(19) United States
(12) Patent Application Publication
(10) Pub. No.: US 2021/0342472 A1
(43) Pub. Date: Nov. 4, 2021

(54) FRAMEWORK FOR MAINTAINING OWNERSHIP OF PERSONAL INFORMATION IN A NETWORK ENVIRONMENT

(71) Applicants: David Forman, Broomfield, CO (US); Julie Rossallini Coker, Boulder, CO (US)

(72) Inventors: David Forman, Broomfield, CO (US); Julie Rossallini Coker, Boulder, CO (US)

(21) Appl. No.: 17/145,594

(22) Filed: Jan. 11, 2021

Related U.S. Application Data
(60) Provisional application No. 62/959,677, filed on Jan. 10, 2020.

(51) Int. Cl. G06F 21/62; G06F 21/60; G06F 21/31

(52) U.S. Cl. CPC G06F 21/6245; G06F 21/31; G06F 21/6209; G06F 21/602

(57) ABSTRACT

The present invention provides a market for empowering users to control what personal information is collected, who can access the personal information, and how it can be used, as well as to monetize their data. In one implementation, the market (600) includes users (602), buyers (604), and patrons (606) who interact via a market platform (608) and a data trust (610). The users (602) are the individuals or entities who own or control the personal or sensitive data. The buyers (604) are generally companies or organizations that are willing to pay for certain data or insights. They can access data from the marketplace for a fee. Patrons (606) are companies or other persons or entities that sponsor data collection. The market (608) lists available data and pricing. It serves as a store front for buyers (604) and patrons (606). The data trust (610) aggregates data from the users (602) and presents data insights to the buyers (604). The market incentivizes users (602) to collect high-quality data while restoring ownership and control of personal or sensitive data to the users (602). In addition, users can use their collected personal data to gain insights about themselves to more effectively pursue their goals and intentions.

### REFERENCE TO RELATED APPLICATIONS

This application is a non-provisional of U.S. Patent Application No. 62/959,677 entitled, “Framework for Maintaining Ownership of Personal Information in a Network Environment,” filed Jan. 10, 2020 (the “Parent Application”) and claims priority from the Parent Application to the maximum extent permissible under applicable laws and regulations. The Parent Application is incorporated by reference herein in its entirety

### FIELD OF THE INVENTION

The present invention relates generally to the accumulation, dissemination, and use of sensitive information of users such as personal information of individuals. More particularly, the invention relates to a system and associated functionality for allowing users to maintain ownership and control of their sensitive information and potentially to monetize their sensitive information, as well allowing for protected sharing and use of sensitive information to advance many useful objections.

### BACKGROUND OF THE INVENTION

In recent years, considerable attention has been devoted to how sensitive information, such as personal information of individuals or proprietary information of individuals or other entities, is collected and disseminated in the context of electronic communications and networks. In the case of individuals, such personal information encompasses a wide variety, and ever evolving, array of data types and sources that identify or relate to individuals. Examples include medical information, financial information, information from social networks, location information, fitness tracking information, videos, network usage data, and other personally identifying or other sensitive information.

Many different legal regimes have evolved to address ownership, access to, and use of personal information. These regimes vary with jurisdictions and types of data and may address such things as notice, opt-in or opt-out requirements, and requirements to “forget” personal data. Generally, these regimes start with the notion that individuals ought to be able to control access to and use of their personal data.

However, the moral rights implicit in this notion have come, in many cases, to seem illusory. For example, in the United States, the individual's rights become less clear when the data is shared. Users of various applications, networks and platforms (e.g., social network platforms) may consent to use and sale of personal data in connection with availing themselves of useful or practically essential technology, in some cases, without appreciating that rights have been granted or without truly voluntary consent.

Relatedly, personal information rights have become a substantial business. Personal information has a tremendous potential value to advertisers, service providers, employers, researchers, and others. Even many conventional businesses have come to see the value of collecting and selling data as a side business and have sometimes developed tracking devices, loyalty programs and the like, at least with one eye towards personal data markets. Not all consumers are comfortable with this degree of data accumulation and exploitation, but many have either resigned themselves to this reality or feel powerless to combat this creeping intrusion.

### SUMMARY OF THE INVENTION

The present invention relates to utilities (systems, components and associated functionality) for empowering users to control what sensitive information is collected, who can access the sensitive information, and how it can be used. Sensitive information is collected from a variety of sources, including from the users themselves and from sources separate from and at least somewhat independent of the users. Users can specify settings pertaining to the sensitive information and an interface, such as an API, may be provided for enabling requesters to access and use the sensitive information. The invention thus enables a number of advantages including: allowing users to better control the accumulation of, access to, and use of sensitive information; provision of independently verified information concerning users, e.g., for social networks, advertisers, and researchers; and the opportunity for users to regain and realize the value of their sensitive information. The invention also allows for easy monitoring of sensitive information sources, privacy settings, access requests, and use of sensitive information. For example, a dashboard may be provided and customized to provide ready confirmation of desired information such as browsing history, requests to access a physical or email address, the identities of parties accessing specified information, or other information tracked by the system.

In accordance with one aspect of the present invention, a sensitive information platform is provided that aggregates sensitive information from multiple sources and allows a user to control use of data from the platform. The platform includes a repository for storing sensitive information and a front-end module for receiving sensitive information, associating the sensitive information with the first user, and storing the sensitive information in the repository. The front-end module is operative for receiving data from multiple sources including from the first user, from a third-party data source, and from a monitoring system that monitors activities of the user. The first user may enter sensitive information into the repository by any appropriate means such as by entering data in response to prompts of a user interface, by uploading files including sensitive information, or by linking the platform to sources of sensitive information of the first user.

The third-party data source may be any source that includes sensitive information of the user including, for example, a database of financial or transaction information, a database of health information, a database of purchasing information (e.g., associated with retail loyalty programs or online purchases), information from social networks, information associated with Internet searches, genetic data, weather data associated with the user, and other sources of sensitive information. Sensitive information may also be obtained from various types of monitoring systems such as health wearables, GPS devices, microphone recorders, cell phone records, traffic monitoring systems internet of things (IoT) devices, biometric devices and the like.

The data from all of these sources may be stored in the repository in raw form or may be processed to obtain processed data such as aggregated data, statistical data, predictive behavior data or other processed data. The platform may further include tools for analyzing the data to provide insights regarding the user or information that can be used in setting personal goals. The sensitive data may be associated with an individual user by metadata such as a user ID or index. Preferably, the repository implements a zero-knowledge storage system where third parties, including administrators of the sensitive data platform, cannot access or use sensitive data other than as allowed by the users. The data and access to the data may be secured by appropriate means. For example, the data may be encrypted and the channels used to access or disseminate the data may be encrypted channels. Preferably, a blockchain system is implemented to continuously record a hash of data transactions, thereby keeping a secure record. The repository may be implemented on one or more machines and may store sensitive data on the cloud or locally or a combination thereof.

The sensitive data platform further includes a back-end module for outputting a selected set of output sensitive data to one or more selected recipients and a sensitive data management module. The sensitive data management module controls outputting of sensitive information based on settings and rules. At least some of the settings are configurable by individual users. In this regard, a user may specify what sensitive data may be provided to whom and how the sensitive data may be used. For example, a user may specify that a first subset of data may be used by social networks, that a second subset of data may be accessed by creditors, that a third subset of data may be accessed by medical providers, and that a fourth subset of data may be accessed in an anonymized form by specified researchers. In this manner, the repository can accumulate a rich and definitive set of sensitive information about users while allowing the users to maintain control over how the sensitive information is accessed and used. The sensitive information may be provided to requesters or shared with other users or specified recipients.

In accordance with another aspect of the present invention, a utility is provided for sharing verified sensitive information in a network environment. For example, a social network system may be provided that can access and publish verified sensitive information. Current social networks generally allow individual users to provide sensitive information. In many cases, this sensitive information has proved to be biased or unreliable. The present invention can be used to allow social networks to access a repository including verified sensitive information so that other users of the social network can have greater confidence in the veracity of the information.

The system includes a data sharing platform, such as a social network platform, for receiving first sensitive information of a first user and making available, to one or more second users, information items of the first sensitive information. In addition, the system includes a repository of sensitive information including second sensitive information of the first user. The second sensitive information includes at least one verified item, where the verified item has third-party source separate from and independent of control by the first user. An interface is provided for transferring data including the verified item from the repository to the data sharing platform. Thus, for example, a social network can thereby provide the verified item of sensitive information within the noted information items. For example, if the social network displays information concerning a user's age or profession, the social network may further indicate whether such data is verified or simply provided by the user.

The system may be used to verify sensitive information in a variety of other contexts. For example, employers may verify education or other credentials, customers can verify licenses and experience of service providers, and schools can verify the accomplishments of prospective students and the finances of students' families. As a further example, the system can be used to verify where someone lives, e.g., that they reside in a neighborhood that has a social group or that they reside within the boundaries of a specified district or jurisdiction. This can be accomplished by entering GPS or GIS information for the residence. That information can be matched to the information sought to be verified. Thus, the location can be verified using detailed sensitive information while outputting only an innocuous confirmation. The system thus enables zero knowledge storage and access as well as zero knowledge verification.

In accordance with another aspect of the invention, a sensitive information system is provided that allows users to monetize the value of their sensitive information as desired. The system includes a repository for storing sensitive information and a user control module for controlling accumulation of and access to sensitive information. The user control module is configurable by a user to control 1) what sensitive information of the first user is stored in the repository, 2) what sensitive information of the user is made available to requesters, and 3) under what conditions sensitive information of the user is made available to requesters.

The sensitive information system further includes a scoring module for analyzing sensitive information of particular users and providing score information concerning one or more attributes of the sensitive information. For example, the score information may relate to an overall quality of the sensitive information such as the completeness of the information with regard to a set of fields of data and/or the reliability of the information as indicated by the sources of the information or redundancy of sources. Alternatively or additionally, the score information may provide values in relation to specified attributes such as income, age, gender, interests, or any other demographic or psychographic attributes of interest.

The system further includes an interface for use by requesters to access sensitive information from the repository. The interface allows for accessing desired sensitive information based at least in part on the score information. A tracking module tracks access of sensitive data from the repository by requesters so as to bill requesters for access to sensitive data of individual users and compensate individual users for providing access to the sensitive data. For example, the amount requesters pay for data may be a function of the score information, the nature of the sensitive information, the intended/allowed use of the sensitive information, the market for the sensitive information, and other factors. The compensation paid to the individual users may be equal to the amount paid by the bill requesters or may be a different amount.

### BRIEF DESCRIPTION OF THE DRAWINGS

For a more complete understanding of the present invention and further advantages thereof, reference is now made to the following detailed description, taken in conjunction with the drawings, in which:

FIG. 1 is a schematic diagram of a system framework in accordance with the present invention;

FIG. 2 is a schematic diagram for a first use case of an information management system in accordance with the present invention;

FIG. 3 is another schematic diagram relating to the first use case of FIG. 2;

FIG. 4 is a schematic diagram for a second use case of an information management system in accordance with the present invention;

FIG. 5 is another schematic diagram of the second use case of an information management system in accordance with the present invention; and

FIG. 6 is a schematic diagram of a data market in accordance with the present invention.

### DETAILED DESCRIPTION

The present invention relates generally to a system and associated methodology for enabling individuals or other users to maintain ownership of sensitive information (e.g., personal or proprietary information) in a network environment (e.g., when using Internet services and functionality). The invention is set forth below in the context of certain specific implementations and architectures. Moreover, the description below sets forth a number of use cases of the invention. However, it will be appreciated that the invention is not limited to the implementations, architectures, and use cases set forth below. Accordingly, the following description should be understood as exemplary and not by way of limitation.

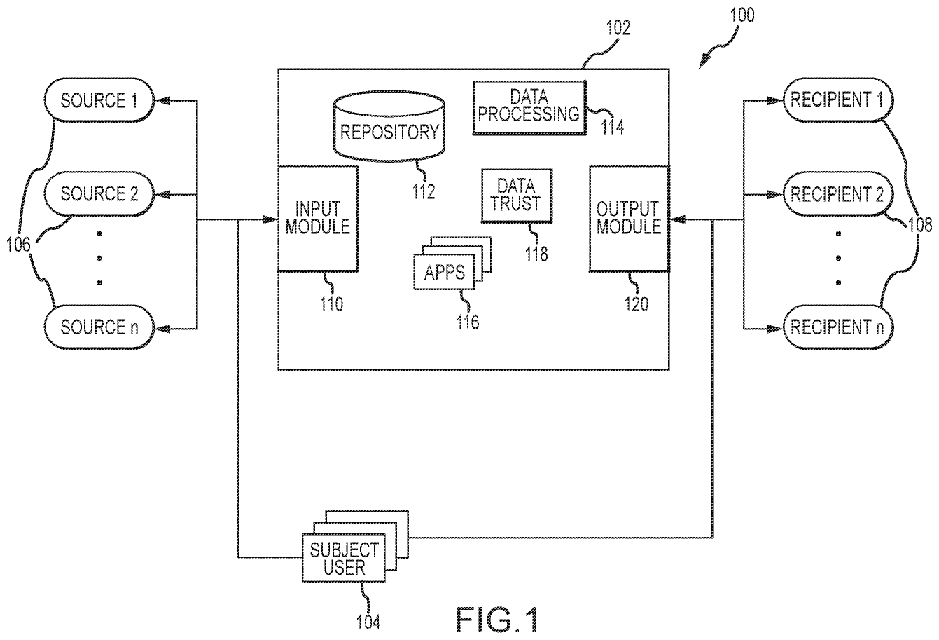

In the following description, various architectures and functionality of the invention are first described in connection with FIG. 1. Thereafter, a number of use cases are described including 1) a personal use example, 2) examples concerning sharing of data, and 3) a data market example. Although the invention is applicable with respect to various types of sensitive data, the examples below will primarily focus on protecting and sharing of personal information of an individual user, which is a particularly useful context of the invention.

Referring to FIG. 1, a personal information management framework 100 in accordance with the present invention is shown. The framework 100 generally includes a management platform 102 for managing personal information of one or more subject users 104. As will be described in more detail below, the platform 102 may ingest personal information of the users 104 from a variety of sources 106 including the users 104, third party sources such as Internet applications and consumer platforms, monitoring devices such as wearables and Internet of things (IoT) devices, and other sources. In addition, the platform 102 can provide output data, based at least in part on the personal information of the users 104, to the user 104 or other recipients 108. Such recipients, as described below, may include social network platforms/members, businesses, targeted advertising platforms, or other entities. It will therefore be appreciated that the users 104 may be sources of personal information and recipients of output information from the platform 102.

For purposes of illustration, the framework 100 is shown as including a platform 102 that includes a number of modules or components. Indeed, the platform 102 may be a cloud-based platform encompassing all of the noted modules or components and associated functionality. In such cases, the platform 102 as well as the modules or components, may be provided on multiple devices at a single location or may be geographically distributed. Moreover, some or all of the modules or components of the platform 102 may be implemented locally rather than being cloud-based. In addition, the functionality of certain components may be distributed between cloud-based and local devices. The functionality of certain components may also be implemented at least in part by third-party service providers.

The illustrated platform 102 generally includes an input module 110, a data repository 112, a data processing module 114, applications 116, a data trust module 118, and an output module 120. The input module 110 receives inputs from the users 104 and other sources 106, processes the inputs to extract personal information and associated metadata or contextual information, and stores the personal information in the repository 112 such that the personal information is associated with the metadata. The metadata may include identification information for a user as well as identifications of fields of information or attributes and values of the information. The data repository 112 securely stores the personal information for access based on permission information of the users. In this regard, the personal information in the repository 112 may be encrypted and/or otherwise secured. A zero-knowledge encryption system may be used. In this manner, nobody will have access to personal data, including the system administrator, unless they have access to a user's password/biometrics. An additional layer of security may be provided for those who want additional protection. When accessing their wallet from a new location, users may be required to verify their identity through an email or text message verification code. In addition, the wallet can be secured by a facial recognition system instead of or in addition to a standard password. As a further alternative, the wallet can use a third-party service to ensure the user is real by requiring the user to take a selfie to login. The repository 112 may be cloud-based, located at a device/network of a user 104, and/or administered on a third-party platform, among other possibilities.

The data processing module 114 may perform a variety of operations on the personal data. For example, the data may be aggregated, filtered, and analyzed to identify trends, anomalies, etc. In addition, the module 114 may process the requests to access personal data, access permissions and limitations concerning access to and use of the personal data, and generate output data. As described below, the module 114 may perform a variety of other functions such as analyzing personal information of particular users to generate a data score, define monetary values based on data scores, market conditions, and or other factors, and apply credits and debits to accounts of users and other parties. The applications 116 may provide a variety of services useful to users 104 or other recipients 108 based on the personal information. These will be described in more detail below, but examples include applications to help users track personal information that is important to them and applications for helping companies establish information sharing structures.

The data trust module 118 allows for verification of inquiries based on personal information without enabling access to personal information in the repository 112. For example, a social network or professional organization might request verification of professional credentials, employment status, age, residence, or other personal information or a user may request that the framework 100 provide verified information to specified recipients. Assuming appropriate permissions, in response to such an inquiry, the trust 118 may access the repository 112 to obtain relevant personal information, compare the personal information to the inquiry, and provide or decline a verification based on a comparison. In this regard, while items of personal information may be transiently cached or otherwise stored for purposes of the verification, the data trust 118 can avoid long-term storage of such personal data, and avoid retention of unencrypted data, so as to enable secure, zero-knowledge processing of verification inquiries. Preferably, the trust 118 will retain no unencrypted personal data.

The output module 120 provides various types of outputs to the users 104 or other recipients 108. The nature of such outputs depends on the context. For example, as noted above, certain recipients 108 may receive verifications of specific items of personal information identified in an inquiry or specified by the user. Users 104 may receive reports concerning access and use of personal information, financial statements, reports concerning progress towards personal goals, graphical or other information reflecting insights based on personal information, and the like. A targeted advertising platform may receive permitted information concerning demographics and interests, as well as permissions and preferences related to targeted advertising. Other recipients may receive financial information, medical information, or other information based on needs and permissions, and such information may be anonymized, aggregated, generalized (e.g., the accuracy of location information may be reduced), or otherwise processed to comply with distribution limitations or to reconcile the needs of the recipient with the access and use settings of the users. The module 120 thus may provide a number of functions including formatting, filtering, addressing, and transmitting data.

It will be appreciated that the module 102 may interact with applications and/or human users (via user devices). In this regard, applications may interact with the input module 110 and output module 120 via an API that defines data formats, messaging, and data fields and values, among other things. The modules 110, 120 may also present user interface elements and receive associated inputs. The interface elements may assist in associating metadata with received personal information. Metadata may also be harvested based on data streams (e.g., IP addresses) and associated platforms (e.g., location gateways).

There are a number of use cases for the data management framework. These use cases include personal use by an individual user, data sharing by a user, and establishing a data market. These example use cases are described below.

Use Case 1—Personal Use

As described above, the data management framework of the present invention may include a private, encrypted data repository, associated data collection tools, and applications. For convenience, these elements may be referred to as an everything wallet or “e-wallet.” The personal use case focuses on collecting data, storing it in a secure manner, and helping users gain transparency, insights, and benefits from their data.

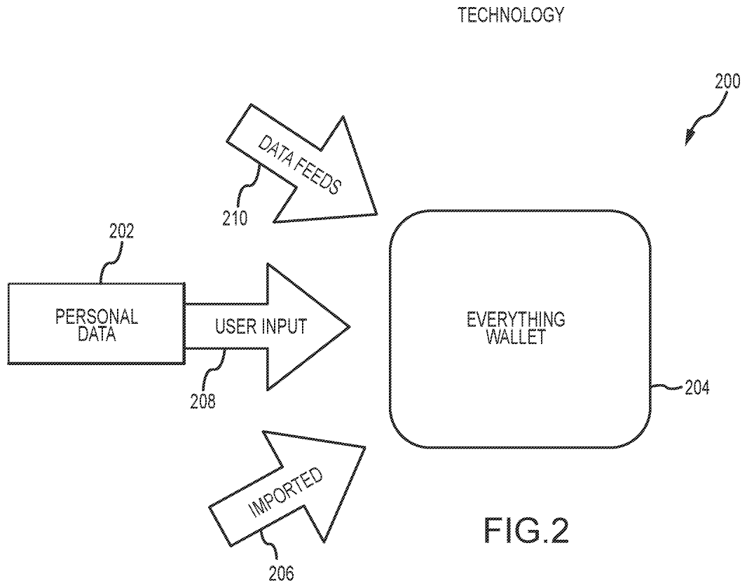

FIG. 2 illustrates a system 200 for collecting personal data 202 in an e-wallet 204. As shown, the personal data 202 may be collected from various sources including imported data 206, user input data 208, and data feeds 210. The imported data 206 may be imported into the wallet 204 from a variety of sources and services that have collected personal data under the traditional paradigm. With the advent of regulations like GDPR and CCPA, users can now download their data from the largest data aggregators in the world. For example, data may be imported from web-based services and entities such as Apple™, FaceBook™, Google™, Amazon™, LinkedIn™, and the like. In general, data may be imported from any such source for storage in the wallet 204. The system can automatically connect to and request data from such services and gain access to the information these companies have about users. In some cases, the services have an API that will enable users to get a real-time feed of any new activity and data through the service. In addition to social networks, consumer and affiliate networks, and networking services, data may be imported from genetic data services (e.g., 23Andme™), health data services, grocery store or other loyalty program memberships, GPS location, weather data, phone usage data, computer usage data, investment tracking sites, images, audio, video, calendar applications, and other sources.

The personal data 202 may also be collected via data feeds 210. These feeds 210 may provide data on a continual or periodic basis. For example, the data feeds may collect information from a computer and phone tracker that yields information regarding browser tracking, application usage, and GPS data. The data feeds 210 may also be linked to various financial accounts to collect financial data including income, investment, and spending data from bank accounts, credit card accounts, investment accounts, and the like. In addition, data may be fed to the wallet 204 from health wearables or other user devices such as FitBit™ devices, smart watches, remote temperature sensors, automobile navigation systems, or other health and wellness wearables. As a further example, the data feeds 210 may collect information from a microphone recorder and transcriber, for example, for convenient data input by a user or other source.

The user inputs 208 may, of course, include personal information that is manually input by a user. For example, such information may be provided by way of surveys or entering profile information. Alternatively or additionally, a user may upload documents including personal information such as resumes, financial documents, or health records. In this regard, the system may include text analysis logic for extracting fields of information and values from such documentary sources and populating the data repository. In addition, the user input data 208 may include data that is collected in an at least partially automated fashion. One of the applications that may be included as part of the wallet 204 is a LifeTrack™ application. This application may be configured by the user to collect information that is important to the user in relation to user defined goals and objectives. The application may include a sleep tracker, a nutrition tracker, an exercise tracker, a health tracker, a time tracker, an emotion tracker, and other user created trackers. Information concerning each of these functions may be entered by the user or harvested from wearables and other devices. This information may be harvested based on a blueprint defined by the user concerning intentions and goals. Moreover, the application may support notes and journaling to supplement the tracker information. The user can connect easily to his data via only a couple of clicks and continuously collect streams of important information. The user can choose to collect all possible information or just information that the user finds important. Users will also be able to input their own data from the application dashboard, including data about mood or emotions, goals, intentions, habits, tasks/to do lists, daily plan and review, journaling, and personality tests.

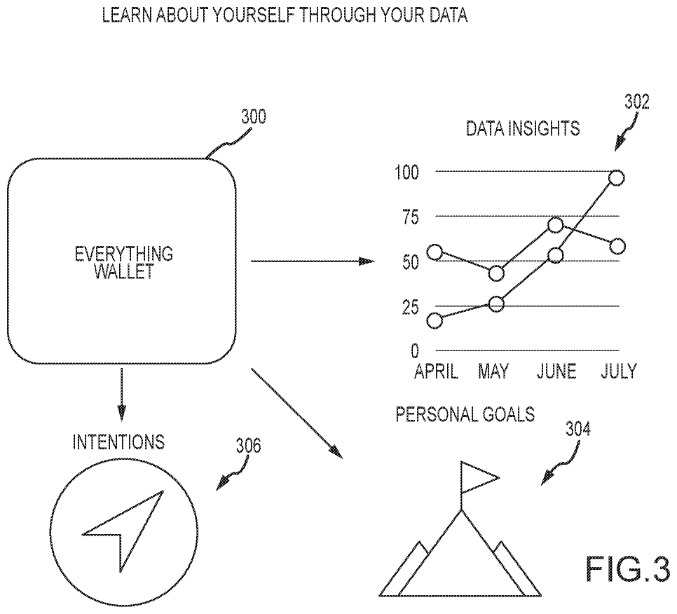

FIG. 3 shows how this application may enable a user to learn about himself/herself based on the collected data. As noted above, a variety of personal information may be collected and processed by the wallet 300. This information may be processed in relation to goals and objectives specified by the user. In addition, the application may provide insights and information based on the data without being prompted by the user. For example, the application may provide data insights 302 in graphical, textual, or other form. Such insights may show trends (e.g., spending treads, activity trends, etc.) Anomalies, or other patterns in the data that may be of interest to the user. In addition, the application may provide information concerning personal goals 304. Such information may show progress towards a defined personal goal and prompt the user to identify additional goals based on the data. The application may also provide information concerning intentions 306. For example, based on information manually input by the user or harvested from data feeds, the application may reveal intentions based on analysis of location, spending, or other habits. It will be appreciated that many types of applications may be provided to generate information of interest to users based on analysis of personal data in the wallet 300.

Use Case 2—Sharing Data

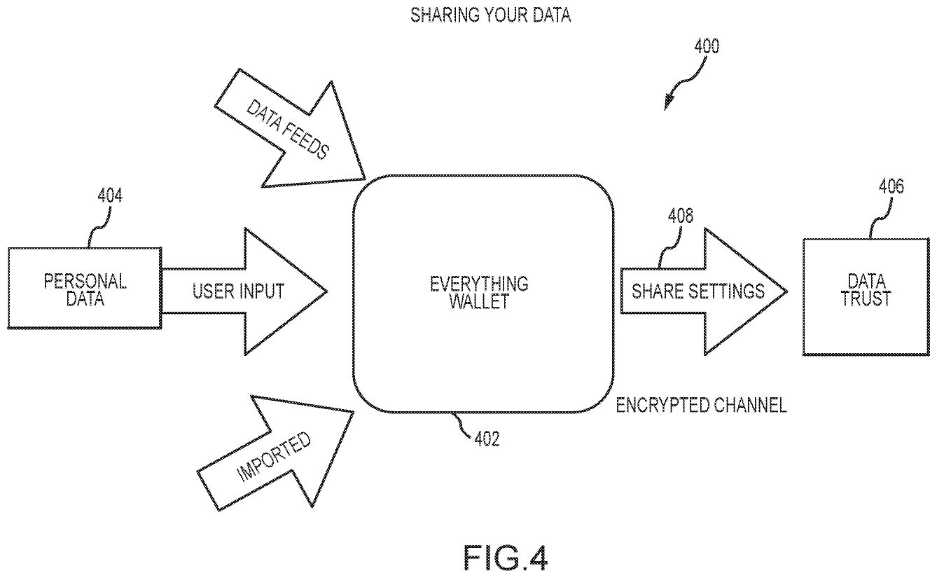

The data management framework is not limited to personal use by the user. In many cases, an individual or entity user may desire to use the framework to securely share data in accordance with rules specified by the user as to who can receive what data for what purposes. FIG. 4 illustrates a system 400 for allowing the user to selectively share data. The system includes a wallet 402 that receives personal data 404 from a variety of sources. The wallet 402 and sources of personal data 404 have been described above. Data to be shared may be transmitted to a data trust 406 via an encrypted channel 408 based on sharing settings specified by the user. The data trust 406 may operate as described above in connection with FIG. 1. The sharing settings may specify, among other things, permitted recipients by individual identity or category, permitted data for each recipient or category of recipient, permitted uses of the data by individual recipients or categories of recipients, and various limitations on distribution of data. For example, such restrictions may include requirements for anonymization, aggregation, generalization, filtering, or other considerations. These settings may be managed via an analytics/insight dashboard. From the dashboard, users can easily share the data, keep it private, or approve on an individual basis. Users can have complete control over what is shared and can easily disable sharing for a dataset at any time, revoking access.

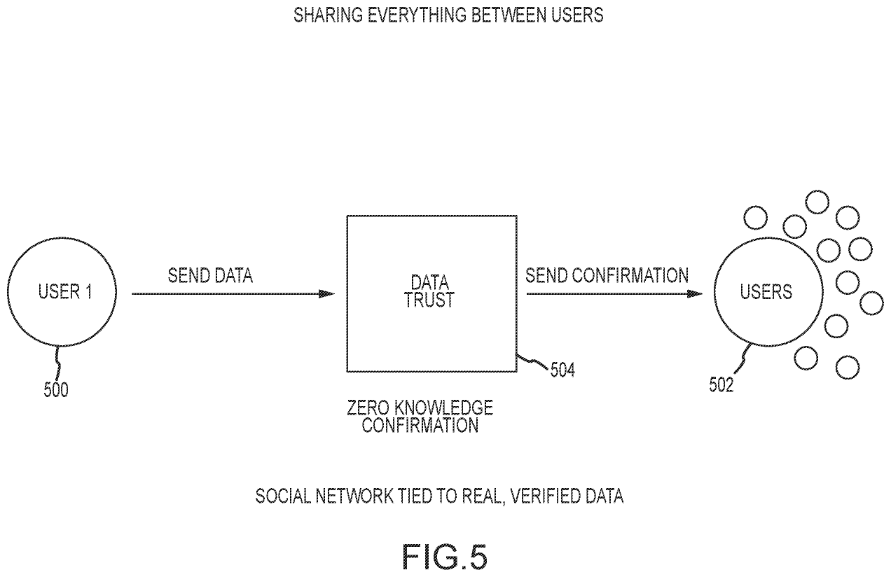

FIG. 5 shows a data sharing example in the specific context of a social network. One difficulty associated with social networks is that data concerning users may be unreliable. In particular, if users are allowed to enter personal information without verification, such information may be unreliable due to intentional misrepresentation or error. The data framework discussed above ingests information from a variety of sources including users and sources independent of users. In addition, the framework can collect a large volume of data over time. Due to the multiple sources including independent sources and the volume of data accumulated, a large volume of accurate and reliable information may be gathered regarding users.

As shown in FIG. 5, a user 500 of a social network 502 may send data intended for the social network 502 to a data trust 504 as described above. The data trust 504 may access a data repository as described above to confirm the data from the user 500. For example, the data trust 504 may verify that the user resides where the user claims to or has certain claimed credentials. A confirmation or confirmed data may then be provided to the social network 502 for access by users of the social network. In this manner, users of the social network 502 may have increased confidence concerning information provided by other users 500. It will be appreciated that such verified information is not limited to use by social networks but may be requested and provided (subject to appropriate permissions) by professional networks, employers, prospective employers, lenders or financial institutions, and others in accordance with the present invention.

Use Case 3—Data Market

A further use case relates to connecting businesses with the user wallets through a secure and permission-based sharing protocol. This allows users to buy and sell data in a secure data marketplace, get sponsored by companies to collect certain data streams, and get connected with advertisements that are relevant to users. This use case may also involve creating wallets and services for businesses.

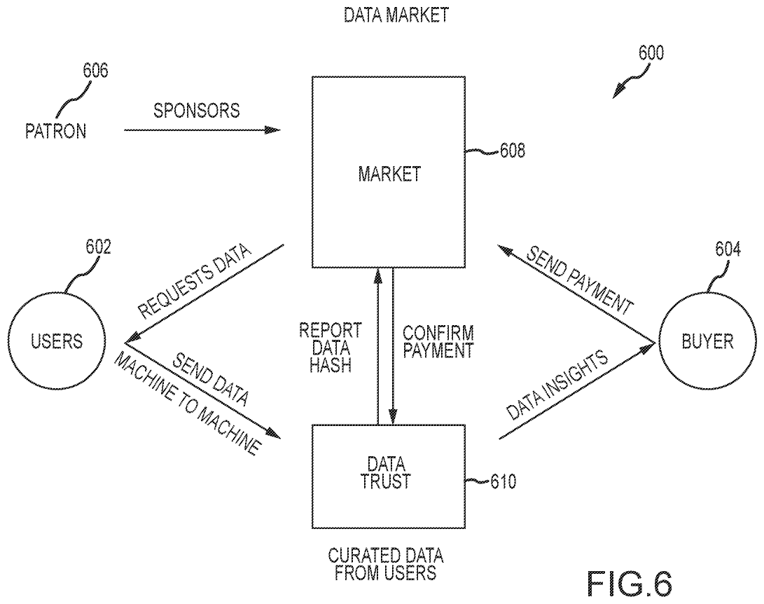

An example of a data market 600 in accordance with the present invention is shown in FIG. 6. The market 600 includes users 602, buyers 604, and patrons 606, who interact via a market platform 608 and a data trust 610. The users 602 are the individuals or entities who own or control the personal data. This may include real and legal persons as well as other entities or groups. Thus, the information available from the users may include all of the stored data and metadata of users. As noted above, users can control and monitor sharing of data via a dashboard. Users can earn revenue directly to a user account after sharing data.

The buyers 604 are generally companies or organizations that are willing to pay for certain data or insights. They can access data from the marketplace for a fee. Patrons 606 are companies or other persons or entities that sponsor data collection. Generally, patrons 606 will want to collect data or data streams that are not readily available in the market 608. They can pay users 602 to collect the desired data, e.g., through surveys, access to IoT or other devices or the like.

The market 608 lists available data and pricing. It serves as a store front for buyers 604 and patrons 606. Finally, the data trust 610 aggregates data from the users 602 and presents data insights to the buyers 604. The data trust 610 works with the marketplace 608 to deliver data with blockchain tracking as described above. A private blockchain system will continuously record a hash of data transactions keeping a secure record. In this manner, users will be able to accurately and reliably track dissemination of individual elements of personal information. The data trust 610 prevents sensitive data from being revealed, while retaining the integrity of the data.

For example, a user may wish to verify a claim that they live in a particular region. To verify this claim, the user sends their GPS record through the data trust. This GPS record may contain very sensitive data, including where that person lives, where they spend most are time, if they've had any unusual GPS behavior recently, and if they visited any controversial locations. However, the output from the data trust is simply a geographic region and can provide a simple yes/no answer based on the user's GPS history.

The data pricing may be based on the quality of the data, the market for the data, and other factors. The quality of the data may be reflected in a data score computed by the data management system in accordance with the present invention. A number of factors may be considered in determining the data score including the quantity or completeness of data, the recency of the data, the reliability of the data as reflected by confirmation from a variety of sources, the importance of the data to potential purchasers, how common or rare the data is, the intended use of the data, and other factors. The data score may be logarithmic in nature. The higher the score, the more compounding value of data is required to raise the score. The data score can also break down all of the streams of data being collected and assign a value score to each of them. This will show the user the value of each data stream and what data they should consider collecting to increase their data score. What factors to use, how they should be weighted, and how the resulting score is translated into market values may be determined based on market conditions and may develop over time. For example, an artificial intelligence or machine learning module may be employed to continuously develop models for scoring and translating scores into monetary values. The system may also provide suggestions on how to increase the data score and value. In this manner, the data score will help gamify the collection of data and incentivize users to collect high quality data.

Thus, the present invention provides a personal data service for individuals, businesses, and organizations that allows users to collect and store all of their data in a single place. The private data storage is connectable to a larger network through permission-based sharing. Users can control who has access to what data and connect with others through data sharing.

Many other applications will be able to connect to the wallet of the present invention for secure, permission-based access to personal information. Examples include a financial planner, a calendar invitation and schedule manager, a sleep tracker, a workout log, a meditation tracker, a pain button, a health buddy, a calendar organizer, and an athletic performance tracker.

In addition, many other data sources are possible. An API may be provided for developers. Users will also be able to store any custom data set in their wallet as well. Data sets that are outside of the provided data collection tools can be imported and utilized allowing for storage of various kinds of data in the wallet. To import custom data sets on a desktop computer, a user can simply drag and drop data files into the wallet folder. In this folder, users can also view all of the data files in a simple window view.

When opening their wallet for the first time, users will be able to see all the different types of data they can collect along with the services they can easily connect to. This list will serve as a starting point for the user for connecting and bringing in all of their data.

The data dashboard is where all of a user's data streams and information is presented. The data dashboard may be shown in a card type presentation, where each card can be dynamically added or taken away. From the dashboard, the user can see all of the different streams of data that are being collected, see what data others are collecting about the user, how they are using the data, and who they are sharing data with, manage connections to new data sources, and track any additional information desired.

The system may provide a new data connections view that contains suggestions on other data sources users can collect including applications, data feeds, and imported connections that the user can easily set up in a few clicks. A data timeline view will allow users to see all of the data being collected and organized by time. For example, users can see the streams and volume of data coming into the wallet in real time, scroll through the past see their data history, and see aggregated sums of data from their collections. A data insights view visualizes all of the data and display insights and correlations.

Using a variety of data tools and preset configurations, users will be able to gain information about themselves and their data, whether it's information that other companies are tracking about them, or insights into how they are spending time. The data insights view can be coordinated with the LifeTrack application to focus on what's important to a particular user and analyze how an individual is progressing on their goals.

Each user may also have a public-facing data profile that they can customize with their accomplishments, data score, and intentions with the purpose of connecting with others. The profile may be completely customizable and a user can choose what to display from their data collection, including nothing. The profile will also be a place that users will be able to publicly display their LifeTrack data, such as intentions, interests, goals, etc. This profile page may be similar to other profiles, but with the key difference of having verified data. If a user has verified credentials, badges, or other claims, they can display that information with a network confirmation. This will allow for truthful profiles that are rooted in the truth of the greater data network.

Similarly, users can connect with communities through their data. Data verification will allow for meaningful discussions to take place where users can join a variety of groups that are verified through data. Unlike traditional social media, these groups will be non-anonymous and will use the collection of data in the wallet as a basis for identity.

For example, geographic base community groups will use GPS location to verify you live in a region. A user can join the community by verifying his GPS position history, so that people in the group are only those who live in that region. This will help generate more meaningful discussions as most social media is global and not local.

Another example is discussion groups for professionals such as physicians. Through verification, the group could be limited to only those who hold valid credentials and are currently practicing physicians. This will allow for people to easily find and connect with a specific group of individuals.

Such verified groups can also utilize data from user-input sources like LifeTrack, allowing users to easily join a discussion with others who have the same intentions, goals, or habits. For example, a group of local individuals who are collecting data about their workout routine would be able to easily interface through a verified group, allowing for new interactions to take place.

Users will also be able to realize the value of their data. The system can compensate users on a monthly basis for the value that their data generates. Value may be realized, for example, by sharing data with companies, allowing targeted advertising, or other uses of the personal data.

For organizations that want specific data that may not exist in the marketplace, that organization can become a patron and sponsor individuals to collect the data for them. Users will be able to easily earn revenue directly from the companies that are sponsoring them, whether it's through connecting to an IOT devices locally, recording user input information, or filling out surveys to help the organization.

For advertisers who want the next level of targeted marketing, and for users who want only relevant advertisements to show up online, a browser advertisement plug-in would connect a user's wallet with the advertisement ecosystem that they engage with online. This plug-in will keep the user's identity and data private but would leverage the wallet's contents through zero knowledge confirmations to only deliver the most relevant advertisements.

Companies, institutions, and organizations will also be able to have a wallet that can connect to the network as described above. Instead of having single users, each such wallet can have a variety of users organized by an administrator. The administrator can change data access privilege for every individual on the organization's wallet account. An organization can use its wallet to store their data, employee data, and users' data in a distributed fashion and connect that data to rest of the network. This will assist companies in collecting customer data while complying with the applicable privacy regulations.

The system will also be able to create a unique digital identity for users. Using a variety of biometric data, location data, and other data points, the system will be able to verify real and unique personhood. The system will help enforce a real identity because it's hard to forge years of legitimate data collection. The higher a user's data score, the more likely it is that they are a real individual. Verification of digital identity will help users interact online without having to interact with bots, trolls, scammers, and malicious parties that will wish to forge a false identity.

The system may also support an AI personal assistant. This AI assistant will leverage all of the user's data in a private system to assist in various functions. For example, the AI assistant can learn from every email, note, journal, and data source the user has connected to the network. Then, the AI assistant will seek to learn how to make the individual's life easier, whether it's helping send and prioritize emails, or ordering their morning coffee. For any AI assistant to be effective, it will need access to the most comprehensive dataset of that individual. The system of the present invention will provide the most comprehensive dataset.

A user can allow others to gain access to the data in their wallet if they are incapacitated and transfer digital assets to designated heirs. For example, a user can assign multiple heirs to their wallet. If a majority of the heirs initiate a retrieval process, the user will receive a notification and option to block the request. If the user doesn't block the request in a given amount of time, the heirs will receive access to the digital assets, distributed in the way the user has designated.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

1. A sensitive data platform, comprising:
a repository for storing sensitive data;
a front-end module, associated with said repository, for receiving sensitive data, associating said sensitive data with a first user, and storing said sensitive data in said repository, said front end module being operative for:
1) receiving a first set of said sensitive data from said first user;
2) receiving a second set of said sensitive data from a third-party data source; and
3) receiving a third set of sensitive data via data feeds for continually providing said sensitive data of said first user;
a back-end module, associated with said repository, for outputting a selected set of output sensitive data to one or more recipients; and
a sensitive data management module, operatively associated with said front end module, said repository and said back-end module, for controlling said outputting based on settings, said settings being configurable by said first user, wherein said settings collectively control said selected set of said output sensitive data in relation to said one or more recipients.

2. The platform as set forth in claim 1, wherein said repository is configured to store said sensitive data in an encrypted form such that accessing said sensitive data requires security information of said first user for decryption.

3. The platform as set forth in claim 1, wherein said repository resides on a cloud-based platform.

4. The platform as set forth in claim 1, wherein said first set of sensitive data is provided in the form of one of survey information and profile information submitted by said first user.

5. The platform as set forth in claim 1, wherein said second set of sensitive data is received at least in part from a third-party data aggregator.

6. The platform as set forth in claim 1, wherein said third set of sensitive data is received from one of a fitness wearable, an IoT device, a GPS device and a health and wellness sensor device.

7. The platform as set forth in claim 1, wherein said backend module is operatively associated with an application for outputting information regarding personal goals based on said sensitive information.

8. The platform as set forth in claim 1, wherein said backend module is operatively associated with an application for providing data insights based on processing of said sensitive information.

9. The platform as set forth in claim 9, wherein said data insights are based on inputs from said first user defining one of data to be tracked and personal goals of said first user.

10. The platform as set forth in claim 1, wherein said sensitive data management module allows for different levels of access to said sensitive data depending on at least an identity of an intended recipient and an intended use of the data.

11. The platform as set forth in claim 1, further comprising a data trust, interposed between said repository and said backend module, for accessing said sensitive information from said repository and providing said sensitive information to said backend module free from storage of unencrypted sensitive information of said first user.

12. A method for controlling user of sensitive data in a network environment, comprising:
storing sensitive data in a data repository;
receiving, at a front-end module, sensitive data, associating said sensitive data with a first user, and storing said sensitive data in said repository, by:
1) receiving a first set of said sensitive data from said first user;
2) receiving a second set of said sensitive data from a third-party data source; and
3) receiving a third set of sensitive data via data feeds for continually providing said sensitive data of said first user;
outputting, via a back-end module associated with said repository, a selected set of output sensitive data to one or more recipients; and
controlling, via a sensitive data management module, operatively associated with said front end module, said repository, and said back-end module said outputting based on settings, said settings being configurable by said first user, wherein said setting collectively control said selected set of said output sensitive data in relation to said one or more recipients.

13. The method as set forth in claim 12, wherein said repository is configured to store said sensitive data in an encrypted form such that accessing said sensitive data requires security information of said first user for decryption.

14. The method as set forth in claim 12, wherein said repository resides on a cloud-based platform.

15. The method as set forth in claim 12, wherein said first set of sensitive data is provided in the form of one of survey information and profile information submitted by said first user.

16. The method as set forth in claim 12, wherein said second set of sensitive data is received at least in part from a third-party data aggregator.

17. The method as set forth in claim 12, wherein said third set of sensitive data is received from one of a fitness wearable, an IoT device, a GPS device and a health and wellness sensor device.

18. The method as set forth in claim 12, wherein said backend module is operatively associated with an application for outputting information regarding personal goals based on said sensitive information.

19. The method as set forth in claim 12, wherein said backend module is operatively associated with an application for providing data insights based on processing of said sensitive information.

20. The method as set forth in claim 19, wherein said data insights are based on inputs from said first user defining one of data to be tracked and personal goals of said first user.

21.-25. (canceled)
